(19) United States
(12) Patent Application Publication
(10) Pub. No.: US 2007/0267331 A1
(43) Pub. Date: Nov. 22, 2007

(54) Structural Arrangement for Vibrating Equipments

(75) Inventor: Andrzej Niklewski, Sao Paulo (BR)

Correspondence Address: DARBY & DARBY P.C., P.O. BOX 770, Church Street Station, New York, NY, 10008-0770, US

(73) Assignee: METSO BRASIL IND. E COM. LTDA, Sorocaba (BR)

(21) Appl. No.: 11/576,403

(22) PCT Filed: Oct. 6, 2004
(86) PCT No.: PCT/BR04/00193

§ 371 Date: Jun. 5, 2007

(51) Int. Cl. B07B 1/00

(52) U.S. Cl. 209/408

(57) ABSTRACT

A structural arrangement for vibrating equipments of the type comprising: a pair of lateral plates (10) seated on elastic support means (30); crossbeams (11) defining at least one level of support floor (15); a screen (12) for classifying bulk product and which is secured on a respective support floor (15); and at least two vibrating devices (20) which are driven to make the equipment vibrate. According to the invention, the structural arrangement comprises at least one intermediate longitudinal plate (40) extended along the length of the equipment, between the two lateral plates (10); and at least two coplanar assemblies of crossbeams (11) defining a respective support floor (15), the crossbeams (11) of each assembly presenting an internal end (11a) rigidly affixed to the intermediate longitudinal plate (40) and an external end (11b) rigidly affixed to the adjacent lateral plate (10), each assembly of crossbeams (11) securing a screen (12) thereon.

### FIELD OF THE INVENTION

The present invention refers to a structural arrangement to be applied to vibrating equipments, such as screens and hoppers, which are generally used for classifying bulk material, such as crushed rocks, ores, etc.

### PRIOR ART

The vibrating screens of bulk material classifying equipments have their screens seated on a support floor formed by a plurality of crossbeams, each crossbeam extending through the whole width of the support floor of the screen and being spaced apart along the longitudinal extension of the screen, the ends of said crossbeams being affixed to respective opposite lateral plates which define the lateral walls of the vibrating screen and form the body of the latter, jointly with the crossbeams and the screen.

A known screen construction, as mentioned above, is illustrated in FIGS. 1, 2 and 3 of the attached drawings. In this basic prior art construction, the vibrating screen comprises two lateral plates 10 which define not only the lateral walls of the body of the vibrating screen but also the structural elements to which are affixed the opposite ends of coplanar crossbeams 11 onto which is mounted a respective screen 12 which constitutes the screen itself. In the illustrated example, there are provided two superposed and spaced apart assemblies of crossbeams 11, each assembly supporting a screen 12 and defining a classification level. The vertical distance between the two screens 12 is determined as a function of the vibrating screen design.

For the generation of the inertial forces responsible for the vibrating movement of the equipment, one or more units for generating inertial forces are provided in the form of vibrating devices 20 which can be mounted to either the upper portion or the lower portion of the screen.

In the construction illustrated in FIGS. 1 and 2, there is provided a vibrating device 20 medianly affixed to a support crossbeam 13, whose opposite ends are each affixed to a respective lateral plate 10 of the vibrating screen body.

In this constructive example, the support crossbeam 13 is positioned on the upper portion of the vibrating screen body, above the upper classification level.

It should be understood that the crossbeams 11 can have the ends thereof affixed to a pair of longitudinal beams (not illustrated), each affixed to one of the lateral plates 10.

FIG. 3 shows an arrangement generally used in large machines, in which two or more vibrating devices 20 are provided secured to a respective support crossbeam 13 disposed either on the upper portion or the lower portion of the vibrating screen body.

FIG. 4 is a schematic cross-sectional view of a known vibrating screen illustrated in FIG. 3, but incorporating a graphic representation of the load generated by the inertial forces acting on the vibrating screen.

In the illustration of FIG. 4, each vibrating device 20 is located at a distance “d” from the adjacent lateral plate 10 corresponding to ¼ the width “L” of the vibrating screen, generating an inertial force “P”. The crossbeams 11 are submitted to a load which is equally distributed and results from the inertial resistance of the carried material plus the weight of the structure of the vibrating screen body.

FIG. 5 illustrates a simplified graphic representation of the distribution of the bending moments “M” to which the crossbeams 11 and the support crossbeam 13 are submitted. These bending moments “M” constitute basic parameters for the structural dimensioning of the vibrating screen body.

It should be understood that the vibrating screen body is adequately mounted on elastic support means 30, usually in the form of springs.

It should be further understood that the vibrating devices could be defined by one or two eccentrics mounted to one or to both the ends of a transversal shaft, externally rotatably supported on the lateral plates 10 and which is driven by a drive unit.

These known structural arrangements for the vibrating equipments have the dimensioning of the elements thereof, particularly the crossbeams 11, the support crossbeam 13 (if present) and the lateral plates, designed so that the structure can resist the inertial acceleration forces to which the product being processed and the structure itself are submitted during operation. The larger the vibrating screen, the larger will be the structural dimensioning to support the bending moments, increasing the mass of the body to be vibrated and consequently the power, the dimensions and also the mass of the vibrating devices 20. The increase of the total structural mass to be submitted to the inertial forces should be kept within certain limits, above which the equipment becomes constructively and economically infeasible.

The limitations mentioned above related to increasing the width of the classifying vibrating equipments considered herein are associated with an important inconvenience in the dimensioning of such equipments. Since the classifying capacity of a vibrating screen is a function of the screen area and since the increase of the width is limited by the structural dimensioning reasons, the solution to obtain the desired productivity is generally based on a larger length for the vibrating screen.

In new plants, the desirable length for the screens should be considered during the project of the plant, allowing the use of longer equipments presenting a structural mass within acceptable limits.

However, when it is desired to increase the classification capacity of a plant already constructed and under operation, the matching of the vibrating screen capacity with the production capacity of other equipments, an increase of the longitudinal extension of the vibrating screens is mostly infeasible, since it requires a substantial and impractical modification of the lay-out of the plant as a whole. In many cases, the solution is to increase the classification area by increasing the width of the vibrating screen or screens, but which solution is hindered by the structural dimensioning limitations mentioned above in relation to FIGS. 4 and 5. Increasing the screen width, which is necessary to provide the desired increase in the classifying capacity of the equipment, can be hindered by said structural dimensioning limitations which, when surpassed, lead to inadvisable or impractical results.

### OBJECTS OF THE INVENTION

From the inconveniences mentioned above which are inherent to the constructive concept of the vibrating screens of the type considered herein, it is an object of the present invention to provide a new structural arrangement to these vibrating equipments, aiming at reducing the mass of the structural elements required to support the inertial forces to which the equipment is submitted under operation and, consequently, reducing the weight or the assembly and the value of the inertial forces to be generated by the vibrating devices.

More specifically, it is an object of the present invention to provide a structural arrangement for the type of vibrating equipment cited above, which allows increasing the width “L” of the conventional screen without increasing the maximum bending moment to which the crossbeams 11 are submitted, i.e., without requiring a greater dimensioning for the profiles of the structural elements.

Depending on the width increase degree desired for the screen, it is possible to obtain said degree by using lighter structural elements, in order to maintain substantially unaltered the structural mass of the wider equipment.

### DISCLOSURE OF THE INVENTION

The present structural arrangement is applied to vibrating equipments of the type comprising: a pair of lateral plates seated on elastic support means; crossbeams interconnecting the lateral plates and defining at least one level of support floor along the equipment; a screen secured on a respective support floor; and at least two vibrating devices carried by the lateral plates.

According to the invention, the structural arrangement comprises at least one intermediate longitudinal plate extended along the equipment between the two lateral plates; and at least two coplanar assemblies of crossbeams, each assembly being disposed on one of the sides of the intermediate longitudinal plate and defining a respective support floor. The crossbeams of each assembly present an internal end rigidly affixed to the intermediate longitudinal plate and an external end rigidly affixed to the adjacent lateral plate, and a bulk product classifying screen being affixed onto each crossbeam assembly.

In general, the structural arrangement comprises more than one level of support floor and also a pair of support crossbeams, superiorly connecting the intermediate longitudinal plate to the lateral plates and supporting, each one, a vibrating device.

### BRIEF DESCRIPTION OF THE DRAWINGS

The invention will be described below, with reference to the enclosed drawings, given by way of example of one embodiment for the structural arrangement and in which:

FIG. 1 is a schematic elevational lateral view of a vibrating screen presenting a prior art structural arrangement;

FIG. 2 is a schematic cross-sectional view of the vibrating screen illustrated in FIG. 1 and presenting only one vibrating device mounted superiorly;

FIG. 3 is a similar view to that of FIG. 2, but illustrating a construction of a vibrating screen with two vibrating devices mounted superiorly;

FIG. 4 is a similar view to that of FIG. 3, but incorporating a graphic representation for the loads generated by the inertial forces acting on the structure of the vibrating screen;

FIG. 5 is a simplified graphic representation of the distribution of the bending moments to which are submitted the crossbeams and the support crossbeams in a prior art construction, as illustrated in FIG. 3;

FIG. 6 is a schematic upper plan view of a vibrating screen presenting a structural arrangement according to the present invention;

FIG. 7 is a schematic cross-sectional view taken according to line VII-VII of FIG. 6;

FIG. 8 is a schematic lateral elevational view of the vibrating screen illustrated in FIGS. 6 and 7;

FIG. 9 is an enlarged lateral view of the region for the fixation of the intermediate longitudinal plate with the crossbeams and with the support crossbeams;

FIG. 10 is a graphic representation of the loads generated by the inertial forces acting on the structural arrangement of the present invention;

FIG. 11 is a simplified graphic representation of the distribution of the bending moments to which the crossbeams and the support crossbeams are submitted in the structural arrangement of the present invention; and

FIG. 12 is a similar view to that of FIG. 7, but illustrating a structural arrangement provided with two intermediate longitudinal plates.

### DETAILED DESCRIPTION OF THE INVENTION

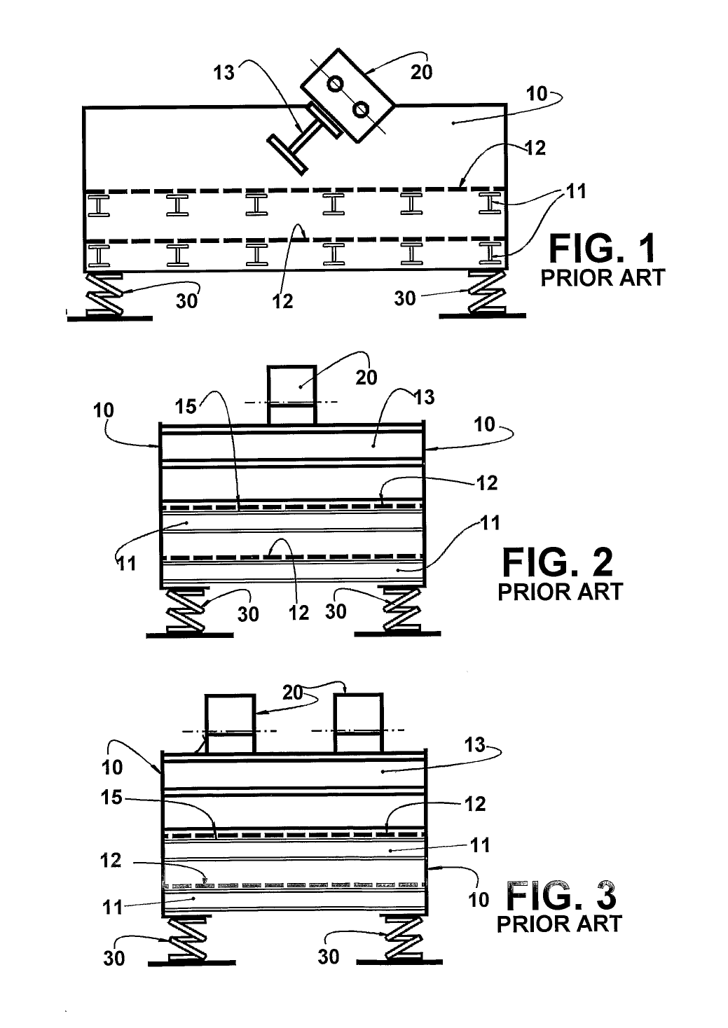

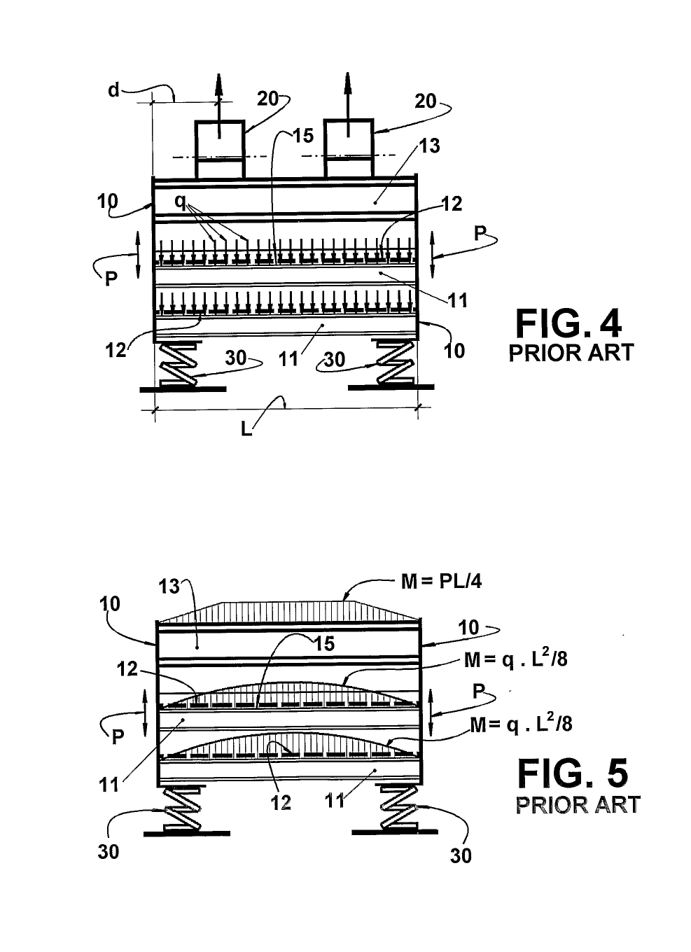

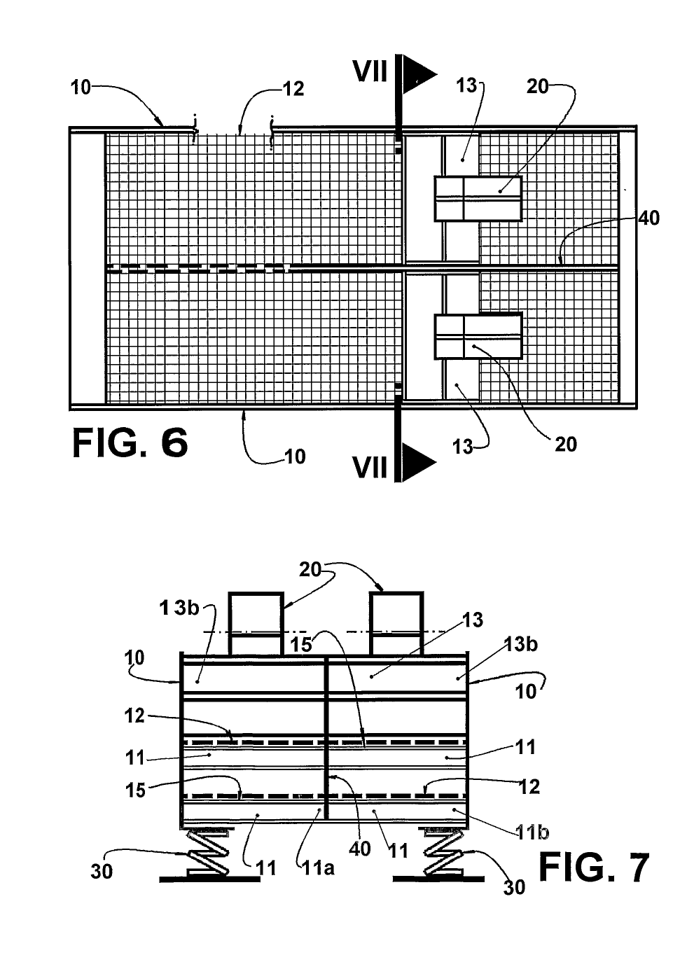

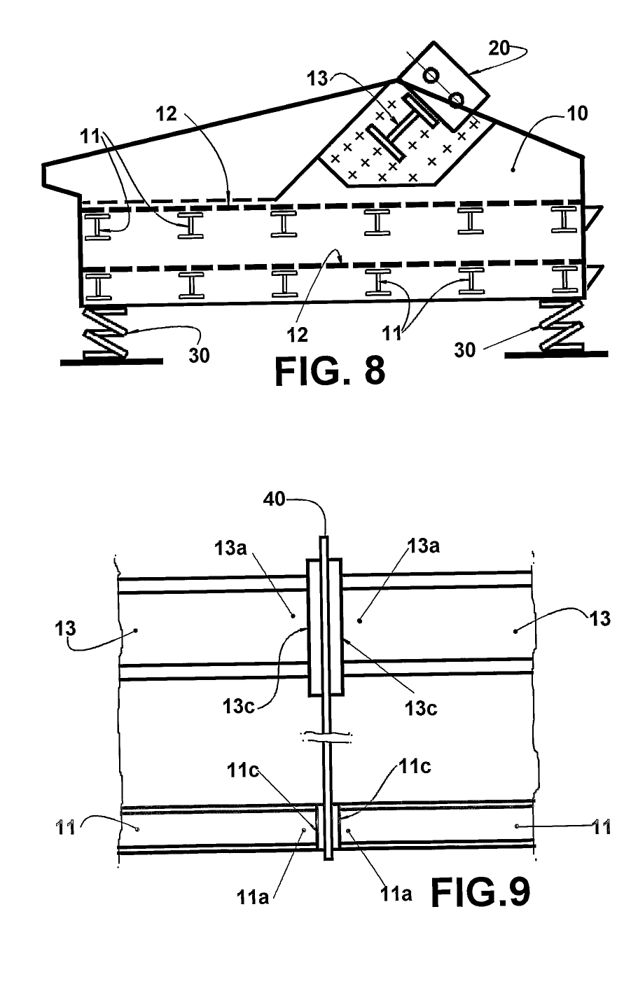

As illustrated in FIGS. 6, 7, 8 and 9, the structural arrangement of the present invention is applied to a vibrating equipment of the type described in relation to FIGS. 1, 2 and 3, in which the common components are designated by the same reference numbers.

Thus, the present structural arrangement is applied to a vibrating screen comprising a pair of lateral plates 10, which define the longitudinal lateral walls of the equipment and which are dimensioned to have a structural function besides the one of laterally closing the screen.

According to the constructive form illustrated for the invention, there is further provided an intermediate longitudinal plate 40 extended along the length of the equipment between the two lateral plates 10 and being parallel to the latter. For locking the plates there is provided at least one pair of coplanar assemblies of crossbeams 11, each assembly being disposed on one of the sides of the intermediate longitudinal plate 40 and defining a respective support floor 15, on which is seated and secured a respective screen 12 of any construction which is adequate to the bulk product to be classified.

The crossbeams 11 of each assembly have an internal end 11a rigidly affixed to the intermediate longitudinal plate 40 and an external end 11b rigidly affixed to the adjacent lateral plate 10, each crossbeam 11 of one assembly being axially aligned with a respective crossbeam 11 of the other assembly.

The lateral plates 10 carry at least two vibrating devices 20, which are driven to make the equipment vibrate on elastic support means 30 generally in the form of spring elements disposed between the lateral plates 10 and a base for supporting the equipment.

In the exemplary mounting arrangement illustrated in FIGS. 6, 7, 8 and 9, there are provided two vibrating devices 30, each mounted on a support crossbeam 13f having an internal end 13a rigidly secured to an upper portion of the intermediate longitudinal plate 40, and an external end 13b rigidly secured to an upper portion of the adjacent lateral plate 10 disposed on one of the sides of the intermediate longitudinal plate 40. Such arrangement covers the gap existing between both lateral plates 10 by means of two support crossbeams 13 axially aligned with each other and which are each located on one of the sides of the intermediate longitudinal plate 40.

The support crossbeams 13 lie on a plane higher than that of the highest support floor 15 of the equipment, each support crossbeam 13 supporting, in its central region, a vibrating device 20.

In the illustrated exemplary construction, there are provided two levels of support floors 15, each level being defined by two coplanar assemblies of crossbeams 11, each assembly being positioned on one of the sides of the intermediate longitudinal plate 40.

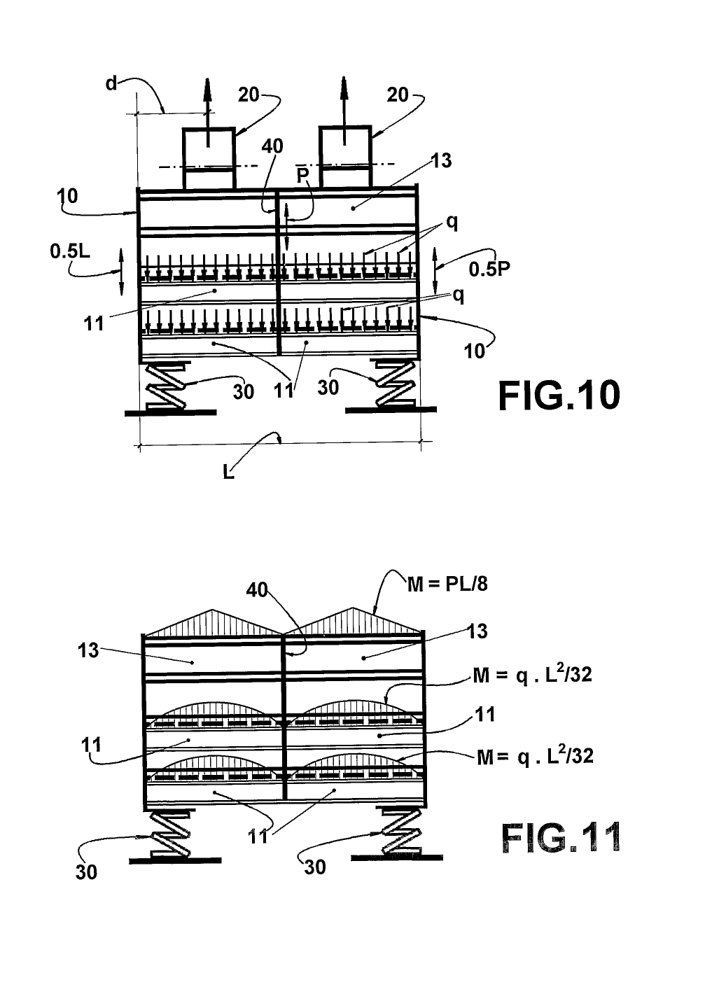

As illustrated in FIG. 9, the crossbeams 11 and the support crossbeams 13 can incorporate flanges 11c, 13c at their internal ends, 11a, 13a, which flanges are seated and rigidly secured, for example by screws, against the opposite sides of the intermediate longitudinal plate 40, sandwiching the latter. In the construction illustrated in FIGS. 6-9, the loads “q”, which are generated by the inertial forces and supported by the structural arrangement, are distributed as illustrated in FIG. 10, in which the vibrating devices 20 are placed in the center of the respective support crossbeams 13, at a distance “d” from the adjacent lateral plate 10, equal to ¼ the width “L” of the vibrating screen.

Considering the inertial loads as being equal to those of the conventional arrangement illustrated in FIG. 4 and as “P” the force generated in each vibrating device 20, the bending moments “M” on the crossbeams 11 and on the support crossbeams 13 will present the behavior illustrated in the graphic representation of FIG. 11. The maximum bending moment “M” on each crossbeam 11 has already been reduced from M=q.L2/8 to M=q.L2/32, whereas the maximum bending moment “M” on each support crossbeam 13 has been reduced from M=PL/4 to M=PL/8.

Due to the fact that the reaction force “P” applied to the intermediate longitudinal plate 40 is twice the value of the forces 0.5 P applied to the lateral plates 10, the latter can be dimensioned to support half or less than half the load “q” distributed on said beams.

As it can be observed from FIG. 11, the force transmitted by the Lateral plates 10 and by the intermediate longitudinal plate 40 corresponds to 2 P, from which 0.5 P is applied to each of the lateral plates 10 and P is applied to the intermediate longitudinal plate 40. The sum of the thicknesses of the three plates can be equal to the sum of the thicknesses of the two lateral plates 10 of the prior art structural arrangement.

By comparing the values of the bending moments, between the structural arrangements of the prior art and those of the present invention, one can verify a reduction to half the bending moment applied to the support crossbeams 13 and a reduction to ¼ the bending moment on the crossbeams 11, which permits reducing the structural profiles of said beams.

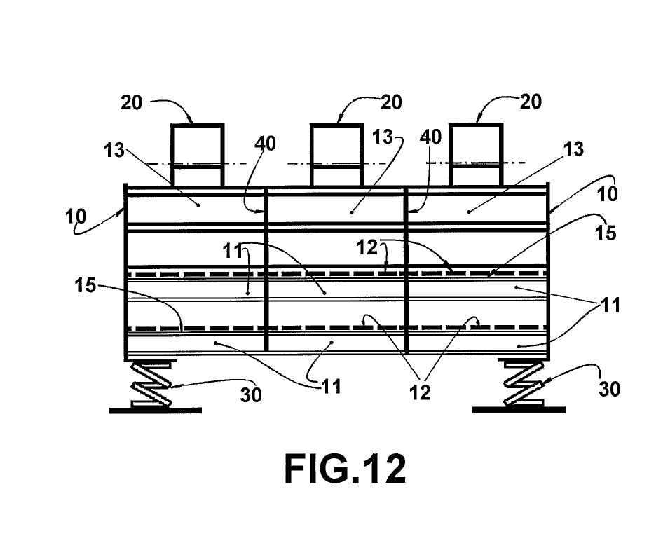

As illustrated in FIG. 12, the structural arrangement of the present invention can comprise more than one intermediate longitudinal plate 40. In the illustrated example, there are provided two intermediate longitudinal plates 40 parallel and equally spaced in relation to each other and in relation to the lateral plates 10. In this case, there are provided crossbeams 11 whose opposite ends are rigidly and respectively affixed to the intermediate longitudinal plates 40 and which are axially aligned with respective crossbeams 11 affixed between each intermediate longitudinal plate 40 and the adjacent lateral plate 10, each assembly of said median crossbeams 11 defining a respective support floor 15 of the screen.

In the arrangement of FIG. 12, there is further provided a support crossbeam 13 having opposite ends respectively secured to the intermediate longitudinal plates 40 and disposed axially aligned with the support crossbeams 13 secured between each intermediate longitudinal plate 40 and the adjacent lateral plate 10, each support crossbeam 13 carrying at least one vibrating device 20. It should be understood that each screen portion defined between two longitudinal walls could be associated with one or two vibrating devices.

The construction described above allows increasing even more the width of a screen without requiring impracticable structural dimensionings.

1. A structural arrangement for vibrating equipments of the type comprising: a pair of lateral plates (10) defining lateral longitudinal walls of the equipment which are seated on elastic support means (30); crossbeams (11) interconnecting the lateral plates and defining at least one level of support floor (15) along the length of the equipment; a screen (12) for classifying bulk product and which is secured on a respective support floor (15), and at least two vibrating devices (20) carried by the lateral plates and which are driven to make the equipment vibrate over the elastic support means (30), characterized in that it comprises at least one intermediate longitudinal plate (40) extended along the length of the equipment, between and parallel to both the lateral plates (10); and at least two coplanar assemblies of crossbeams (11), each assembly being disposed on one of the sides of the intermediate longitudinal plate (40) and defining a respective support floor (15), the crossbeams (11) of each assembly presenting an internal end (11a) rigidly affixed to the intermediate longitudinal plate (40) and an external end (11b) rigidly affixed to the adjacent lateral plate (10), each assembly of crossbeams (11) securing a screen (12) thereon.

2. Structural arrangement, according to claim 1, characterized in that each crossbeam (11), disposed on one of the sides of the intermediate longitudinal plate (40), is axially aligned with a respective crossbeam (11) disposed on the other side of the intermediate longitudinal plate (40).

3. Structural arrangement, according to claim 1, characterized in that it comprises a support crossbeam (13) on one of the sides of the intermediate longitudinal plate (40), each support crossbeam (13) having an internal end (13a) rigidly affixed to an upper portion of the intermediate longitudinal plate (40) and an external end (13b) rigidly affixed to an upper portion of the adjacent lateral plate (10), said support crossbeams (13) being disposed on a plane superior to that of the highest support floor (15) of the equipment.

4. Structural arrangement, according to claim 3, characterized in that the support crossbeams (13), each disposed on each of the sides of the intermediate longitudinal plate (40), are axially aligned with each other.

5. Structural arrangement, according to claim 3, characterized in that each support crossbeam (13) supports, in its central region, a vibrating device (20).

6. Structural arrangement, according to claim 3, characterized in that it comprises two levels of support floors (15), each level being defined by two coplanar assemblies of crossbeams (11) and each assembly being positioned on one of the sides of the intermediate longitudinal plate (40).

7. Structural arrangement, according to claim 1, characterized in that the intermediate longitudinal plate (40) has its thickness dimensioned to support twice the load carried by the lateral plates (10).

8. Structural arrangement, according to claim 1, characterized in that it comprises two intermediate longitudinal plates (40), which are parallel and equally spaced apart in relation to each other and in relation to the lateral plates (10), there being provided at least one assembly of coplanar crossbeams (11) with the opposite ends rigidly and respectively affixed to the intermediate longitudinal plates (40) and disposed axially aligned with respective crossbeams (11) secured between each intermediate longitudinal plate (40) and the adjacent lateral plate (10), said assembly of crossbeams (11) defining a respective support floor (15).

9. Structural arrangement, according to claim 8, characterized in that it comprises a support crossbeam (13) with opposite ends respectively affixed to the intermediate longitudinal plates (40) and disposed axially aligned with the support crossbeams (13) affixed between each intermediate longitudinal plates (40) and the adjacent lateral plate (10).
